(19) United States
(12) Patent Application Publication
(10) Pub. No.: US 2016/0373170 A1
(43) Pub. Date: Dec. 22, 2016

(54) ANTENNA AUGMENTATION PERIPHERAL SELECTION AND MANAGEMENT SYSTEM AND METHOD

(71) Applicant: MOTOROLA MOBILITY LLC, Chicago, IL (US)

(72) Inventors: Istvan J. Szini, Grayslake, IL (US); Prashanth B. Alva, Gurnee, IL (US); Krishna K. Bellamkonda, Lake Zurich, IL (US); Brett Robertson, Mundelein, IL (US)

(21) Appl. No.: 14/742,068

(22) Filed: Jun. 17, 2015

(51) Int. Cl. H04B 7/04; H04W 72/08; H04B 7/06

(52) U.S. Cl. CPC H04B 7/0417; H04B 7/0632; H04W 72/082

(57) ABSTRACT

A mobile device accesses antenna equipment of at least a first antenna augmentation peripheral (AAP) using a first set of radio channels for communication between the mobile device and the first AAP and uses a second set of radio channels for communication with a wide area network (WAN). The mobile device receives a first performance metric for at least one channel of the second set of radio channels from the first AAP using the first set of radio channels. The mobile device determines a composite performance metric using the first performance metric and a second performance metric related to the second set of radio channels. The mobile device transmits the composite performance metric as the mobile device performance metric to the WAN and obtains a downlink radio resource assignment from the WAN based on the composite performance metric.

### CROSS-REFERENCE TO RELATED APPLICATIONS

Field of the Disclosure

The present disclosure relates generally to antennas and multiple-input, multiple-output (MIMO) antennas systems with diversity reception, and more particularly to mobile devices employing such MIMO antenna systems.

Background

Mobile devices may incorporate multiple antennas, or an antenna array, for diversity reception and for implementing spatial multiplexing. Spatial multiplexing involves splitting a high data rate signal into two or more separate data streams that are intended to arrive at a receiver antenna array with different spatial signatures such that the two or more separate data streams can be reassembled to construct the high data rate signal. At least two separate mobile device antennas, or two antenna elements of an antenna array, each receive one of the separate data streams. Therefore, spatial multiplexing may be considered a form of antenna diversity reception.

The goal of antenna diversity reception is to take advantage of decorrelation between the diversity antennas. The decorrelation may be achieved by physical placement, polarization or by using differing antenna beam patterns. Mobile device diversity and MIMO (multiple-input, multiple-output) antenna systems have been developed based on static figure-of-merit (“FoM”) requirements, total efficiency, gain imbalance and envelope correlation coefficient values (i.e. antenna correlation) that are fixed regardless of prevalent operating parameters or the environment in which the mobile device is operating.

Performance of the MIMO system may be negatively impacted by changes in the radiated channel conditions and the user's position and handgrip on the mobile device, because the hand position may impair radio frequency (RF) reception by the MIMO antennas. For this and other reasons, challenges exist for achieving good performance of diversity antenna systems in a mobile device.

### BRIEF DESCRIPTION OF THE DRAWINGS

FIG. 1 is a diagram of a system in which a mobile device may communicate with and use various antenna augmentation peripherals (AAPs).

FIG. 2 is a diagram of the mobile device communicating with a group of selected AAPs to achieve a multiple-input/multiple-output antenna (MIMO) receive configuration in accordance with an embodiment.

FIG. 3 is a block diagram of an AAP in accordance with an embodiment.

FIG. 4 is a block diagram of an example mobile device in accordance with an embodiment.

FIG. 5a is a block diagram of a bitmap for sending AAP modality information as an AAP relevance signature (AAP-RS) message in accordance with an embodiment and FIG. 5b provides an example of bit fields within the bitmap.

FIG. 6 is a flow chart of an example mobile device process for setting up an AAP group in accordance with an embodiment.

FIG. 7 is a flowchart of an example process for obtaining AAP modality data by an AAP aggregation entity in accordance with an embodiment.

FIG. 8 is a flowchart of an example mobile device process for selecting AAPs and forming an AAP group in accordance with an embodiment.

FIG. 9 is an example CQI composite table in accordance with the embodiments.

FIG. 10 is an example composite coding rate table in accordance with the embodiments.

FIG. 11 is a flowchart of an example mobile device process for obtaining downlink channel assignments from a wide area network.

### DETAILED DESCRIPTION

Briefly, the disclosed embodiments provide an antenna augmentation peripheral (AAP) selection and management system and methods of operation for a mobile device. A mobile device may include an AAP aggregator in accordance with the embodiments that invokes AAP devices to form a group and to utilize antennas of the AAP devices to form a multi-antenna input system (i.e. receive system) for the mobile device. The AAP aggregator evaluates, among other things, AAP device modality and estimates at least one radio frequency (RF) performance metric to select AAP devices to maximize that performance metric during operation.

One aspect of the present disclosure is a method of operation for a mobile device. The method includes accessing antenna equipment of at least a first antenna augmentation peripheral (AAP) using a first set of radio channels in a first frequency band for communication between the mobile device and the first AAP and using a second set of radio channels in a second frequency band for communication with a wide area network (WAN) to form a multiple input antenna system. The mobile device receives a first performance metric for at least one channel of the second set of radio channels measured by the first AAP that is sent to the mobile device using the first set of radio channels. The mobile device determines a composite performance metric using the first performance metric and a second performance metric related to the second set of radio channels. The composite performance metric is reported to the WAN as the mobile device performance metric. The mobile device may then receive a downlink radio resource assignment from the WAN based on the composite performance metric.

The mobile device may obtain the second performance metric for a second channel from a second AAP. The mobile device can allocate the downlink radio resource assignment to one of the first AAP or the second AAP based on the first performance metric or the second performance metric. The mobile device may also estimate a coding rate gain for the second set of radio channels in communication with the WAN using historical data or empirical data for the first AAP and the second AAP, and may use the coding rate gain estimation to select the first AAP and the second AAP from a group of AAPs.

The mobile device may obtain additional radio resource allocations by implementing a short burst data traffic session as a speed test of the WAN for high bandwidth operation, and estimating a coding rate gain for the multiple input antenna system comprising the first AAP and the second AAP. The composite performance metric using the estimated coding rate gain can be determined and reported to the WAN to obtain additional downlink radio resource assignments. In one approach, the mobile device may aggregate application data to simulate a high bandwidth, full buffer condition to implement the short burst data traffic session.

The first set of radio channels in the first frequency band for communication between the mobile device and the first AAP may utilize an unlicensed frequency band while the second set of radio channels in the second frequency band for communication with a WAN may use a licensed frequency band.

Another aspect of the present disclosure is a method of operation for a mobile device where the mobile device may obtain modality data from a group of AAPs by communicating with each of the AAPs using a wireless interface and determine the available AAPs based on the modality data. The mobile device may assign radio channels of a first set of radio channels in a first frequency band to each available AAP for communicating with the mobile device, and may assign radio channels of a second set of radio channels in a second frequency band to each available AAP for communicating with a WAN. The mobile device uses the AAPs to form a multiple input antenna system for the mobile device.

The mobile device measures signal-to-noise-plus-interference ratio (SINR) for available radio channels in the second set of radio channels and creates an ordered list of available radio channels based on the SINR. The ordered list of available radio channels is then mapped to the AAPs.

The modality data may be obtained as a packet having a plurality of bit fields, with each bit field containing AAP operating mode information. The mobile device may assign a numerical value to each bit field such that each packet received from each AAP has an associated numerical value related to availability. The mobile device may then create a list of AAP's using the numerical value and may select available AAPs of the group by selecting each AAP based on its associated numerical value.

Another aspect of the present disclosure is a mobile device that includes antenna equipment with one or more antennas; radio transceiver equipment, operatively coupled to the antenna equipment, non-volatile, non-transitory memory comprising a composite channel quality indicator (CQI) table for determining a composite CQI for a first channel and a second channel in a multiple-input antenna system; and a processor operatively coupled to the memory and to the radio transceiver equipment. The mobile device is operative to perform all of the methods of operation and processes described in the present disclosure.

The transceiver equipment is operative to communicate with one or more AAPs using a first set of radio channels in a first frequency band to form a multiple input antenna system, and operative to communicate with a WAN using a second set of radio channels in a second frequency band. The processor is operative to access antenna equipment of at least a first AAP, receive a first CQI value for at least one channel of the second set of radio channels measured by the first AAP, determine a composite CQI using the first CQI value and a second CQI value related to the second set of radio channels, report the composite CQI to the WAN as the mobile device CQI, and obtain a downlink radio resource assignment from the WAN based on the composite CQI.

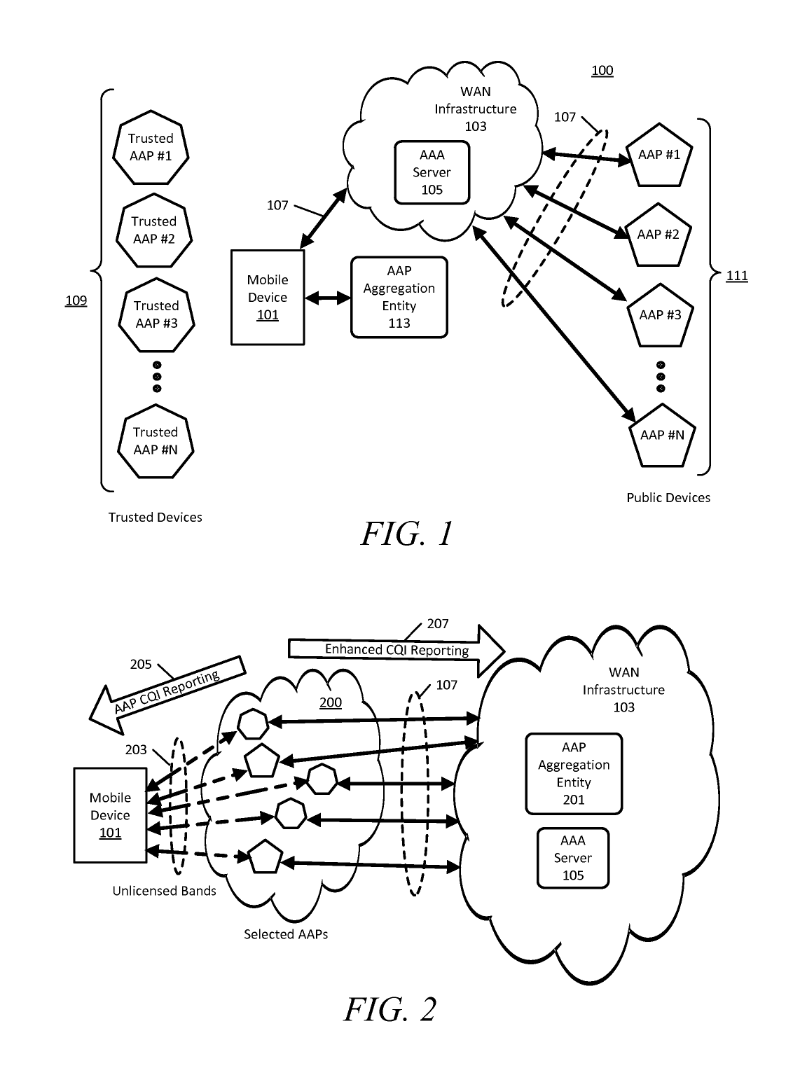

Turning now to the drawings, FIG. 1 illustrates a system 100 in which a mobile device 101 may communicate with various antenna augmentation peripherals (AAPs) for the purpose of leveraging each AAP's antennas to form a distributed multiple-input/multiple-output (MIMO) antenna system. More particularly, among other benefits, the use of AAPs enhances receive antenna diversity by taking advantage of the inherent decorrelation between physically separated antennas of different AAPs. The AAPs may be trusted devices 109 or may be public devices 111. The trusted devices 109 may include, but are not limited to, smartwatches, automobile antenna systems, electronic key fobs, a personal mobile hotspot or other device designed specifically as an AAP, or other mobile devices. Public devices 111 may be other mobile devices (belonging to other users), and AAPs specifically placed and designated for public use.

Each of the AAPs, whether trusted devices 109 or public devise 111, are capable of communication with a wide area network (WAN) infrastructure 103 over a wireless interface 107 such as a Long Term Evolution, 4^{th} Generation (4G LTE) wireless interface. The WAN infrastructure 103 includes base station equipment (such as eNode B), Evolved Packet Core Network, and any other equipment, including any legacy equipment, necessary for implementing the WAN. The WAN infrastructure 103 also includes an authentication, authorization, and accounting (AAA) entity, namely AAA server 105, which authenticates any device interacting and communicating with the WAN infrastructure 103.

The mobile device 101 also communicates with the WAN infrastructure 103 using the wireless interface 107, and also communicates with an APP aggregation entity 113. In the various embodiments, the AAP aggregation entity 113 may be a component of the mobile device 101, may be included in the WAN infrastructure 103, or may be distributed between the mobile device 101 and the WAN infrastructure 103. The AAP aggregation entity 113 determines and lists available AAPs that the mobile device 101 may access and utilize to enhance receive antenna diversity and bandwidth. The AAP aggregation entity 113 obtains modality data from the AAPs and assigns AAP groups that may best provide antenna augmentation for the mobile device 101 based on location and historical data collected for certain AAPs and AAP groups over time. A database of such information may be contained in the mobile device 101, in the WAN infrastructure 103 or distributed between the mobile device 101 and the WAN infrastructure, just as can be done with the AAP aggregation entity 113. FIG. 2 provides an example in which an AAP aggregation entity 201 is included in the WAN infrastructure 103 along with the AAA server 105.

An AAP group 200 of selected AAPs is designated by the AAP aggregation entity 201 and identified to the mobile device 101 over the wireless interface 107. The members of the AAP group 200 are authenticated by the AAA server 105 and connection information is provided to the mobile device 101 by the AAP aggregation entity 201. The mobile device 101 uses the connection information to connect and communicate with each AAP of the AAP group of selected AAPs to achieve a MIMO receive antenna configuration, more particularly a multiple input antenna receive system. In accordance with the example embodiment of FIG. 2, the AAPs communicate with the mobile device 101 over unlicensed bands 203 rather than the licensed bands of the wireless interface 107. For example, the unlicensed bands may be in the ultra-wide-band spectrum (3.1 to 10.6 GHz) but are not limited to any specific unlicensed spectrum.

Examples of AAP devices may include, but are not limited to, laptop computers, personal digital assistants (PDA), a tablet or e-book readers, mobile telephones or smartphones, smartwatches, mobile hotspots or other devices that include the appropriate antenna system and transceivers to at least receive and up/down convert a radio signal and transmit the converted signal over an unlicensed band. Additionally, some AAP devices may, from time-to-time, establish a network connection with an AAP aggregation entity such as AAP aggregation entity 201 or AAP aggregation entity 113 shown in FIG. 1. The AAP aggregation entity 201 may be a server that resides within the WAN infrastructure 103 or may be a cloud-based server on the Internet that is operatively coupled to the WAN infrastructure 103 by Internet Protocol (IP) connectivity. The AAP aggregation entity 201 is operative to obtain modality data (referred to herein as an AAP relevance signature or “AAP-RS”) from each of the AAPs and to generate AAP group lists that the AAP aggregation entity 201 can send to the mobile device 101 using a routing or push mechanism. The AAP aggregation entity 201 may also collect modality data from the mobile device 101. When utilized, each AAP of the AAP group 200 reports its respective wireless interface 107 CQI 205 (or CSI) to the mobile device 101 over the unlicensed bands 203. The mobile device 101 in turn determines a composite CQI 207 (or equivalent coding rate) and reports this information to the WAN infrastructure 103 such that the WAN infrastructure 103 does not directly receive and channel reporting (i.e. CQI or CSI) from the AAPs. The composite CQI 207 is also referred to herein as “enhanced CQI.”

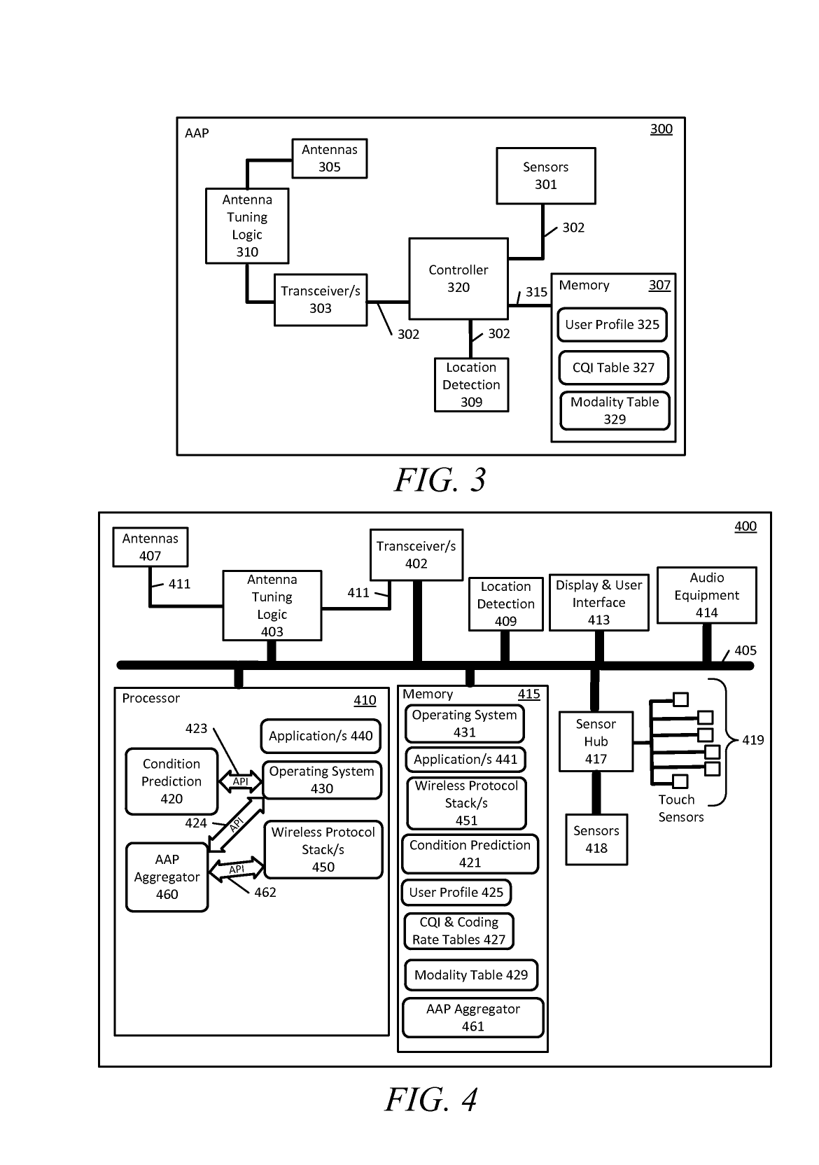

Modality data includes information regarding the mode of use of the AAP (or mobile device) such as the AAP's movement and speed, orientation in space, how the AAP is being held with respect to user grip on the AAP device, applications running on the AAP device, etc., that can be used to determine how the AAP is being used at a given point in time. For example, when the AAP is a wearable device such as a smartwatch, the modality data may indicate that the AAP user is running and using a heart rate monitor feature of the smartwatch. In another example where the AAP is a mobile device, the modality data may indicate that the mobile device user is engaged in a phone call. The modality data may be used to determine, among other things, whether a potential AAP is engaged in a connection with the WAN infrastructure 103 such that it is not a candidate for use as an AAP. Further details of an example AAP 300 are provided in FIG. 3.

In the present disclosure the term AAP includes both “passive” AAP devices and “active” AAP devices. A passive AAP is one that includes an antenna system and radio frequency (RF) up/down conversion capability but no signal decoding capability. In other words, a passive AAP includes an RF subsystem but does not include a baseband component. An active AAP is one that includes the baseband component in addition to the antenna system such that it can decode signals. For example, the mobile device 101 shown in FIG. 1 and FIG. 2 could serve as an active AAP for another mobile device under certain conditions.

Turning to FIG. 3, the example AAP 300 is a generic example in that it may be considered either a passive AAP or an active AAP. The example AAP 300 includes a controller 320 operatively coupled by one or more internal communication buses 302 to one or more transceivers 303, location detection hardware 309 and sensors 301. The controller 320 is also operatively coupled to non-volatile, non-transitory memory 307 via a read/write memory bus 315. The AAP 300 may also include antenna equipment with antenna tuning logic 310 operatively coupled to the antennas 305 and to the transceivers 303. The sensors 301 may include one or more touch sensors which may be capacitive sensors or infrared (IR) type sensors that may be used to detect when the user is wearing or holding the AAP device and the type of grip that is being used. The sensors 301 may also include an accelerometer and gyroscope, temperature sensors, audio sensors, or any other type of sensor, etc. In some embodiments, the controller 320 is operative to receive sensor data from the sensors 301 and analyze the sensor data to determine the device modality. The memory 307 may store a user profile 325 that contains user settings, and a modality table 329 which may provide a modality identifier for a given set of sensor 301 outputs such that the controller 320 may perform a table lookup operation to obtain a modality identifier. For example, one set of sensor 301 outputs may be associated with walking, running, being in a vehicle, etc., each of which may be an identified modality in the modality table 329. The controller 320 is operative to control operations of the AAP 300 based on settings in the user profile 325 that correspond to given modalities specified in the modality table 329. For example, if the AAP 300 is a smartwatch, the controller 320 may execute a heartrate monitor if the controller 320 receives sensor data from the sensors 301 that correspond to the user running by performing a comparison of the sensor data with the modality table 329. The controller 320 is also operative to transmit the modality information to a mobile device using unlicensed RF bands or to an AAP aggregation entity which may be integrated into the mobile device or may be implemented in a WAN or as a cloud-server as described above. Modalities include, among other things, various handgrips that may be used in gripping a mobile AAP, positions of the AAP with respect to a user's head or body, dock mode, concealed mode, battery charge percentage, applications running, movement and orientation, and/or other information that may be detected by sensors (such as proximity sensors, light sensors, accelerometer/gyroscopes, touch sensors) etc. These modalities may be mapped to changes in SINR and CQI and may be geotagged and time stamped (i.e. associated with a location, time, etc.).

The transceivers 303 are operative to receive one or more data streams over the wireless interface 107 and to report CQI (channel quality indicator) and CSI (channel state information) to a mobile device using unlicensed bands 203 of the wireless interface 107 (such as 4G LTE unlicensed bands). The controller 320 is also operative to create a CQI table 327 that associates modalities from the modality table 329 with CQI values when the AAP 300 operates to receive data streams. The CQI tables 327 may be reported to an AAP aggregation entity of a mobile device or to a network based AAP aggregation entity. The controller 320 is operative to receive commands from a mobile device as described below, to tune to desired channels in order to receive data streams for which CQI is measured and reported.

In FIG. 4, an example mobile device 400 includes at least one internal communication bus 405 which provides operative coupling between the various components. Each of the various components of the mobile device 400 that are operatively coupled to the communication bus 405 may accordingly send information to, or receive information from, a processor 410. In addition to the processor 410, the mobile device 400 components include, but are not limited to, transceivers 402, antenna selection and tuning logic 403, antennas 407, location detection logic 409 (such as, but not limited to, a GPS receiver), display and user interface 413, audio equipment 414, memory 415, and a sensor hub 417.

The sensor hub 417 is operatively coupled to various sensors 418 which may include thermal sensors, proximity sensors, accelerometers, gyroscopic sensors, light sensors, etc. The sensor hub 417 is also operatively coupled to a set of touch sensors 419 which are positioned about the housing of the mobile device 400 and which are operative to sense the user's hand and fingers when placed upon the housing, and to send data to the sensor hub 417. The touch sensors 419 may be optical sensors, capacitive sensors, or combinations of both. The sensor hub 417 is a low power processor that offloads the processor 410 from some tasks such as obtaining data from the sensors 418 and from touch sensors 419. For example, the sensor hub 417 may provide functions while the processor 410 is placed in a sleep mode in order to conserve mobile device 400 battery power. The sensor hub 417 is operative to receive data from the various sensors and to convey the data to the processor 410 over the internal communication bus 405. The sensor data is therefore related to the mobile device 400 modality at any given point in time.

The mobile device 400 antennas 407 may include various MIMO diversity antennas. The antennas 407 are operatively coupled to the transceivers 402 by RF coupling 411. In some embodiments, the antennas 407 may also be operatively coupled to antenna selection and tuning logic 403 by RF coupling 411, and to the transceivers 402. Each antenna or antenna array may be evaluated by a figure-of-merit (FoM) or by signal quality metrics.

The processor 410 is operative to execute instructions (also referred to herein as “executable instructions,” “executable code” or “code”) stored in memory 415, including operating system executable code 431 to run at least one operating system 430, wireless protocol stack code 451 to run one or more wireless protocol stacks 450, and application (or “user space”) executable code 441 to run one or more applications 440.

In some embodiments, the processor 410 is also operative to execute condition prediction code 421 to implement condition prediction logic 420, and to execute AAP aggregator code 461 to implement AAP aggregator 460. The condition prediction logic 420 may interact and communicate with the operating system 430 by one or more APIs of a suite of APIs 423 (application programming interfaces) or by other appropriate operative coupling. The condition prediction logic 420 is operative to communicate with the sensor hub 417 to obtain data from the touch sensors 419, the sensors 418 or combinations thereof. This modality data may include information about the position of the mobile device 400, such as whether the mobile device 400 is stationary, in a docking station, placed flatly on a table surface, etc. and other information related to the ambient environment surrounding the mobile device 400. The location detection logic 409 may also be accessed by the condition prediction logic 420 to obtain location information for the mobile device 400. The condition prediction logic 420 may collect and aggregate this data into a user profile 425 stored in memory 415.

The data contained in the user profile 425 is time and date stamped and geotagged using location data from the location detection logic 409. The operation of the condition prediction logic 420 may also be present in an AAP such as AAP 300 described in FIG. 3. The condition prediction logic 420 may obtain data from the touch sensors 419 and from position sensors and other sensors or sensors 418, and may create the user profile 425 that includes the obtained data for use in predictions. For example, the condition prediction logic 420 may obtain SINR (signal-to-noise-plus-interference ratio) measurement data, or some other RF system related measurement, from the transceivers 402 over the internal communication bus 405. By creating associations between various modalities, locations, and SINR, signal-to-noise ratio (SNR) or other measurement data, the condition prediction logic 420 may later anticipate RF connectivity problems based on detected modalities in combination with location, based on the assumption that previous measurement data will indicate that similar poor performance, or similar good performance, will occur. For example, if stored data exists where the user modality was a mobile phone call at a specific location and the user's hand grip position (as sensed by touch sensors 419) is similar and resulted in a dropped call, the condition prediction logic 420 can anticipate a dropped call (i.e. loss of RF coverage) and take action to mitigate or prevent this occurrence. One mitigation action may be to invoke one or more AAPs to enhance MIMO receive coverage at a given location, for a predicted or detected mobile device 400 modality, or a combination of such factors. For this purpose the AAP aggregator 460 may be invoked.

The AAP aggregator 460 communicates with the operating system 430 using an API 424 and with the wireless protocol stacks 450 using an API 462, and is operative to obtain SNR and CQI measurements form the transceiver/s 402 for at least two MIMO streams in a rank 2 transmission. The AAP aggregator 460 may access a CQI and coding rate tables 427 stored in memory 415, and also a modality table 429 in some embodiments. The AAP aggregator 460 is also operative to request modality data from potential AAPs and to assign rankings to the AAPs based on received modality data. The AAP aggregator 460 may control the mobile device 400 to establish connections with AAPs and to assign communication channels over licensed and unlicensed bands. Therefore the processor 410 may also communicate with controller 320 of the example AAP 300 and may command the AAP 300 to tune to any of a first set of channels of a first frequency band (such as an unlicensed band) to communicate with the mobile device 400 and to tune to any of a second set of channels of a second frequency band (such as a licensed band) to communicate with a WAN. These commands may initially be sent using a wireless interface such as IEEE 802.11x (WiFi®), Bluetooth®, etc., and may subsequently be sent over the unlicensed band after the AAP accordingly tunes to its assigned channels in response to the mobile device command.

In some embodiments, the AAP aggregator 460 may interact with the condition prediction logic 420 to obtain predicted modality information and may determine when to invoke AAP connections based on these predictions by accessing the modality table 429 and CQI and coding rate tables 427 and obtaining an expected coding rate (or expected CQI values) for previously used AAPs and the predicted modality. Further details of these operations are described below.

It is to be understood that any of the above described software components (i.e. executable instructions or executable code) in the example mobile device 400 or any of the other above described components of example mobile device 400 may be implemented as software or firmware (or a combination of software and firmware) executing on one or more processors, or using ASICs (application-specific-integrated-circuits), DSPs (digital signal processors), hardwired circuitry (logic circuitry), state machines, FPGAs (field programmable gate arrays) or combinations thereof. Therefore the mobile devices illustrated in the drawing figures described herein provide examples of a mobile device and are not to be construed as a limitation on the various other possible mobile device implementations that may be used in accordance with the various embodiments.

More particularly, condition prediction logic and/or the AAP aggregator may be a single component or may be implemented as any combination of DSPs, ASICs, FPGAs, CPUs running executable instructions, hardwired circuitry, state machines, etc., without limitation. Therefore, as one example, the condition prediction logic may be implemented using an ASIC or an FPGA. In another example, the AAP aggregator may be a combination of software or firmware executed by a processor that makes the decision regarding when to switch to establish connections with and/or use a particular AAP etc. These example embodiments and other embodiments are contemplated by the present disclosure.

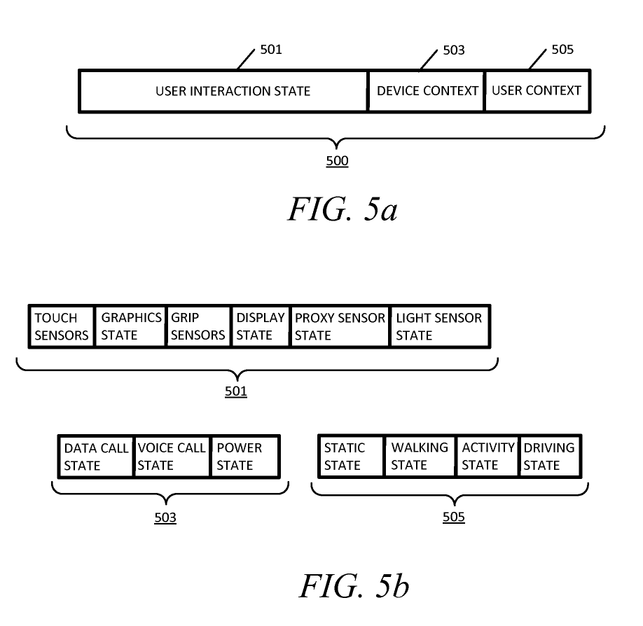

Turning to FIG. 5a and FIG. 5b, a format for receiving modality data from AAPs in accordance with some embodiments is provided. FIG. 5a illustrates a bitmap 500 of an AAP relevance signature (AAP-RS) which is a message that is received by the mobile device 400 from one or more AAPs. The term “bitmap” as used in the present disclosure refers to the arrangement (i.e. mapping) of bit fields in one or more data packets used for transmission of the information represented by the bit fields. The “bitmap” indicates which bit positions in the data packet represent what information. Put another way, the AAP-RS bitmap 500 is a format for transmitting the modality data of the AAPs to the AAP aggregation entity for assessment. As discussed with respect to the example mobile device 400, the AAP aggregation entity may be a component of the mobile device such as AAP aggregator 460. However it is to be understood that an AAP aggregation entity may be a network function in some embodiments, or may be distributed between a network function and a mobile device component. In one example embodiment, the AAP aggregator 460 manages AAPs that are trusted devices 109 while a network entity such as AAP aggregation entity 201 manages AAPs that are public devices 111 as well as managing authentication by communication with the AAA server 105. In this approach, the mobile device may interact with a combination of trusted devices 109 as AAPs along with public devices 111 as AAPs with the AAP aggregation entity 201 providing the connection information and credentials (based on AAA server 105 authentication) such that the mobile device can establish connections. In that case, the AAP aggregation entity 201 requests the AAP-RS from the public devices 111 while the mobile device AAP aggregator 460 requests the AAP-RS from the trusted devices 109.

In any of the above possible embodiments, the AAP-RS bitmap 500 includes a user interaction state field 501, a device context field 503 and a user context field 505. FIG. 5b provides example details of the three primary bit fields. For example, the interaction state field 501 may include a touch sensors bit, graphics state bit, grip sensors bit, display state bit, proximity sensor state bit, and a light sensor bit. A logical bit value of “1” may indicate “on” while a logical bit value of “0” may indicate “off” The device context field 503 may include a data call state bit, voice call state bit, and power state bit. For the data call state and voice call state, a logical bit value of “1” may indicate “idle” while a logical bit value of “0” may indicate “active.” For the power state, a logical bit value of “0” may indicate a power state of greater than twenty-five percent charge, while a logical bit value of “0” may indicate any level equal to or below twenty-five percent.

The user context field 505 may include bit fields for static state, walking state, activity state, and driving state. Alternatively, these states can be covered by a two bit field where “00” indicates a driving state, “01” indicates an activity state, “10” indicates a walking state, and “11” indicates a static state. The bitmap 500 may also include parity bits and/or a cyclic redundancy check (CRC) field in some embodiments. The bitmap 500 may also be extended to include location information in some embodiments. For example a field for GPS coordinates may be included. The AAP-RS bitmap 500 bit fields may be viewed as a numerical value based on the resulting binary number or hexadecimal number resulting from the populated bit fields. This individual bit fields numerical values, the entire AAP-RS bitmap 500 numerical value or both, may be considered a “score” related to the “availability” of the AAP. For example, a battery charge under twenty-five percent would result in a lower score for the related bit field than an AAP battery charge above twenty-five percent. In this way, an overall score may be determined such that AAPs may be placed in an ordered list based on the score, which is related to the AAP-RS bitmap 500 numerical value and overall AAP modality. The “availability” of an AAP as used herein may therefore be related to the overall score with some AAPs having higher availability scores than others. The AAPs with the highest availability scores would therefore be selected first and some AAPs would be rejected as unavailable (for example AAPs already engaged in a WAN connection or serving another mobile device as an AAP, etc.).

Returning briefly to FIG. 2, the AAP aggregation entity 201 may query AAP public devices 111 and receive the AAP-RS bitmap 500 from each queried device accordingly. Based on the modality of the AAP as indicated by the AAP-RS bitmap 500, the AAP aggregation entity 201 can determine which AAP devices are available to the mobile device 101, or other mobile devices, communicating with the WAN infrastructure 103. The AAP aggregation entity 201 may send AAP lists to the mobile devices, such as mobile device 101, which the mobile devices may then use to form an AAP group such as the AAP group 200 illustrated in FIG. 2.

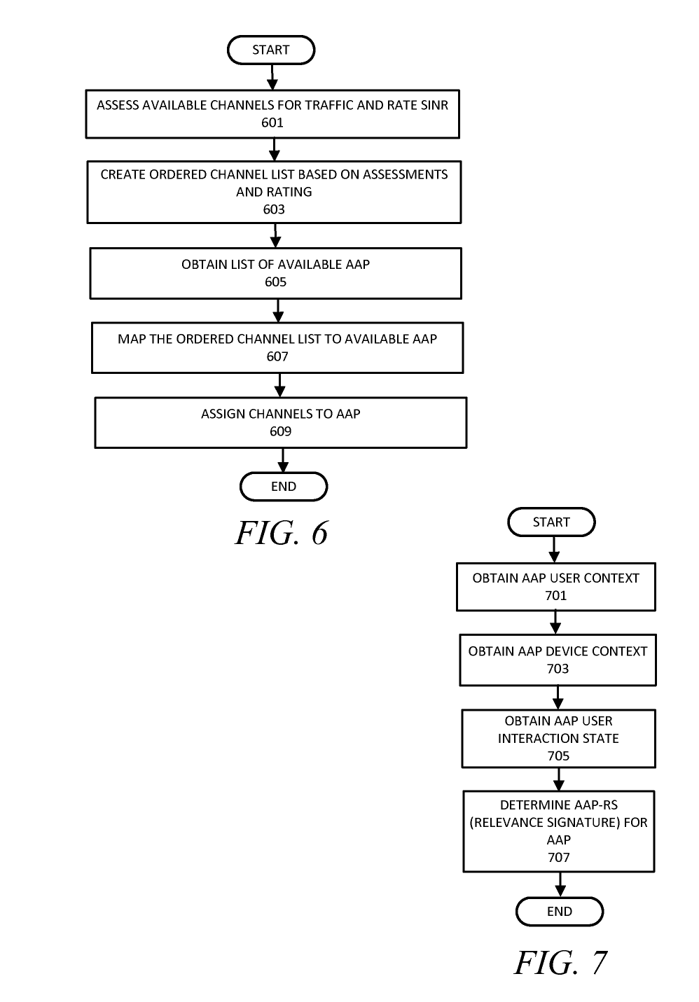

One process in a mobile device related to forming an AAP group is illustrated by the flowchart of FIG. 6. In operation block 601, a mobile device assesses available channels (i.e. unlicensed bands for communication with the AAPs) for traffic and rates the SINR for those channels. In operation block 603, the mobile device creates an ordered channel list based on the assessments and rating. For example, the channels may be listed from best to worse SINR or based on some other metric. In operation block 605, the mobile device obtains a list of available AAPs. This list may be provided by a network based AAP aggregation entity in some embodiments. However, in the example of mobile device 400, the AAP aggregator 460 may generate the list based on a set of trusted devices. In operation block 607, the mobile device maps the ordered channel list to the available AAPs. The modality of the AAPs, based on the AAP-RS bitmap 500, may be a factor in how the channels are mapped. More particularly, some activities or AAP operations may be more suitable for channels with better SINR values or vice versa. This may be known from empirical data or from historical data collected and stored by a network based AAP aggregation entity, or by a mobile device AAP aggregator and stored in memory. The AAP aggregator may also take into account physical distance between the mobile device and the candidate AAP based on location information which may be included in the AAP-RS bitmap 500 or sent separately. In operation block 609, the mobile device assigns unlicensed channels to the AAP for AAP to mobile device communication.

The AAP aggregation entity may collect the AAP-RS information as shown in FIG. 7. In operation block 701 the AAP aggregation entity obtains AAP user context information such as walking state, activity state or driving state. In operation block 703, the AAP aggregation entity obtains AAP device context which may include data call state, voice call state, and power state (i.e. battery power available) for the AAP device. In operation block 705, the AAP aggregation entity obtains AAP device interaction information which may include touch sensor data, graphic state data, grip sensor data, display state data, proximity sensor data, and light sensor data. In operation block 707, the AAP aggregator may determine an AAP-RS value for the AAP that may be used for comparison with other AAPs. For example, the bit fields shown in FIG. 5b for the AAP-RS bitmap 500 may be viewed as a hex value such as “0x01f” which might indicate that the user is walking and interacting with the device (in other words an AAP availability score). Because of the user interaction, the AAP device would not be a candidate for MIMO connectivity in this example because the AAP is considered not available.

In embodiments in which the aggregation entity resides on the mobile device, such as in FIG. 4, the condition prediction logic 420 may assist the AAP aggregator 460 to select available AAPs by providing an initial setting (i.e. an estimated coding rate gain for previously used AAP groups prior to determination of the actual SNR condition for an AAP modality and/or AAP group). More specifically, the condition prediction logic 420 may obtain additional data from AAPs, in addition to data received from the touch sensors 401 and other sensors 418 of the mobile device 400 itself, and may add the obtained data to the user profile 425 for use in AAP group CSI-gain or coding rate gain predictions. For example, the condition prediction logic 420 may collect user history for data call and voice calls including time stamps and location data stamps and store this history information in the user profile 425. The condition prediction logic 420 or the AAP aggregator 460 may also collect the AAP-RS bitmap 500 from tethered AAPs from time-to-time. This data collection may be done only when an AAP group is being used, or may be collected from AAPs for various modalities on a predetermined schedule (such as daily, some hourly schedule, etc.). In some circumstances where the trusted AAPs are used for purposes other than for AAP functionality, the AAPs may be tethered to the mobile device using wireless interfaces such as IEEE 802.11x (WiFi®), Bluetooth®, etc. In those circumstances, the AAP-RS bitmap 500 may be sent over those wireless interfaces used for tethering. At those times, the condition prediction logic 420 or the AAP aggregator 460 may also obtain SINR measurement data from the AAPs (for example, as observed on a 4G LTE unlicensed band) and from the mobile device for data calls and voice calls. Based on these past activities and associated measurements, the condition prediction logic 420 may therefore then predict the SINR for one or more AAPs or for a group of AAPs based on past SINR measurements associated with these past activities by reading the user profile 425. For example, if the user profile 425 data shows that the user routinely makes a data call at 3:00 pm on a certain day and time, and at a certain location, and has used one or more trusted devices as AAPs with certain channels and the measured SINR values are recorded, then the condition prediction logic 420 will make this prediction determination and will pass this information to the AAP aggregator 460. In this way, the MIMO diversity antenna arrangement using AAPs appropriate for the predicted condition can be selected in advance which enhances the mobile device 400 performance and the user's experience with the device.

For public devices 111 the AAP aggregator 460 may collect this historical data whenever it uses one of the public devices 111 as an AAP where such public devices 111 are at a fixed location or on public transportation. Such public device AAPs may operate similar to wireless local area (WLAN) access points (or may be WLAN access points) in that they may have a detectable BSSID and use associated connection security protocols. In the case of using other mobile devices as AAPs (i.e. a bandwidth sharing type of arrangement), a network based AAP aggregation entity 201 can obtain real time SINR information and AAP-RS bitmaps 500 from the mobile devices to determine appropriate AAP groups and send that information to the mobile device 101. In other words, the AAP aggregation function may be done locally in some instances, via a network entity, or by combinations of both. The public devices 111 that are other mobile devices require authentication by the AAA server 105 and the connectivity information for these devices is sent to the mobile device 101 by the network based AAP aggregation entity 201. For trusted devices 109, these devices inherit the trust relationship with the mobile device 101 as the master device as is accomplished when forming tethered connectivity such as through 802.11x or Bluetooth® connection establishment.

When the AAP aggregator 460 forms an AAP group for MIMO purposes, the selection of the unlicensed bands takes into consideration the avoidance of co-channel and adjacent channel interference and assigns the channels to the AAPs accordingly. In some embodiments, a frequency hopping scheme can also be employed on the AAP to mobile device channels to further improve performance and reduce channel interference as well as RF fading aspects.

As known by those of ordinary skill, standards map CQI to coding rate. The 3GPP TS 36.213 V12.1.0 (2014-03); 3rd Generation Partnership Project; Technical Specification Group Radio Access Network; Evolved Universal Terrestrial Radio Access (E-UTRA); Physical layer procedures (Release 12) (2014), which is hereby incorporated by reference herein, defines the “Channel Quality Indicator (CQI)” and provides a table mapping CQI index to coding rate for a SISO (Single-Input Single Output) system. In accordance with the embodiments, a mapping adapted to a rank 2 MIMO transmission is used that represents a composite CQI when AAPs are employed for MIMO reception. The coding rate translates to throughput in bits-per-symbol (bps).

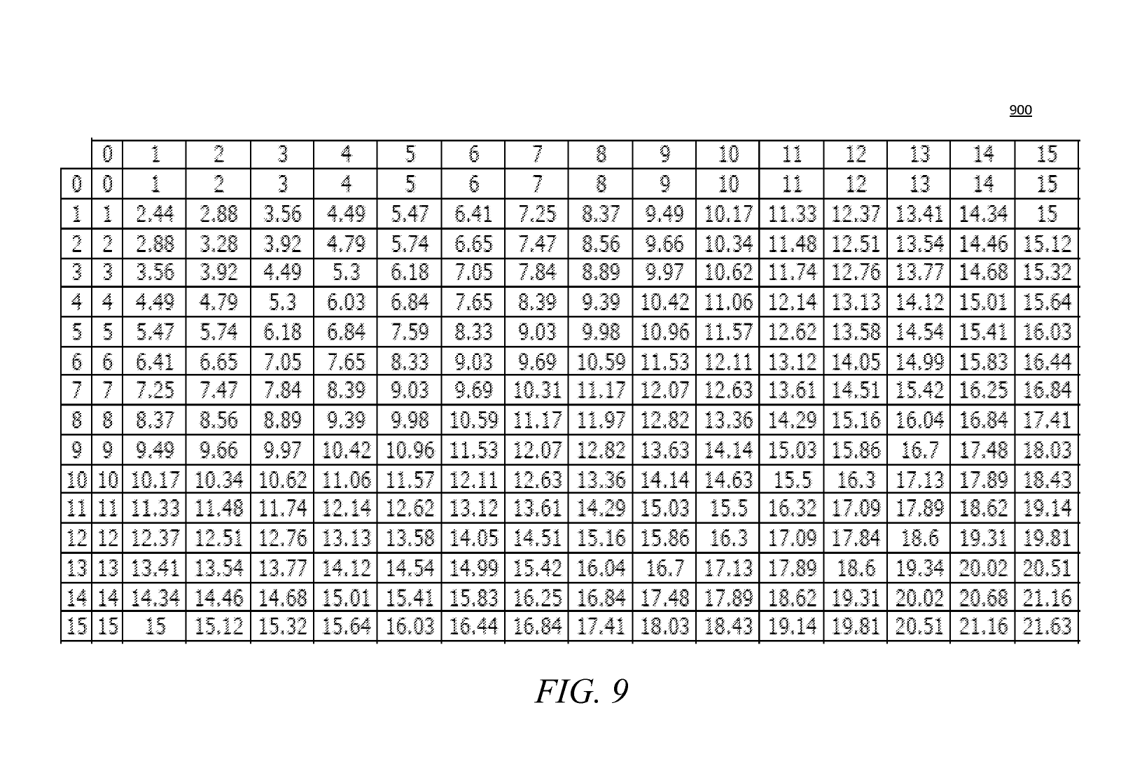

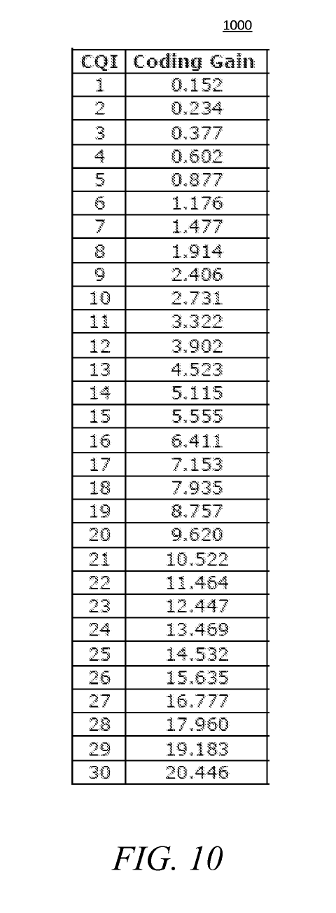

For the present embodiments the inventors have developed a CQI equivalence table for a composite CQI for a rank 2 system with channel 0 and channel 1 (CQI-Ch0, CQI-Ch0) where a CQI from a first AAP observation and a second AAP observation may be used to determine a composite CQI from the lookup table. This table is stored in the CQI and coding rate tables 427. Another form of the table maps channel 0 and channel 1 CQI values to a composite coding rate in bits-per-second-per-Hertz (b/s/Hz) and this table can also be stored in the CQI and coding rate tables 427. Either or both of these tables may be accessed by the AAP aggregator 460. An example of the CQI composite table 900 is provided as FIG. 9 and an example of the composite coding rate table 1000 is provided as FIG. 10.

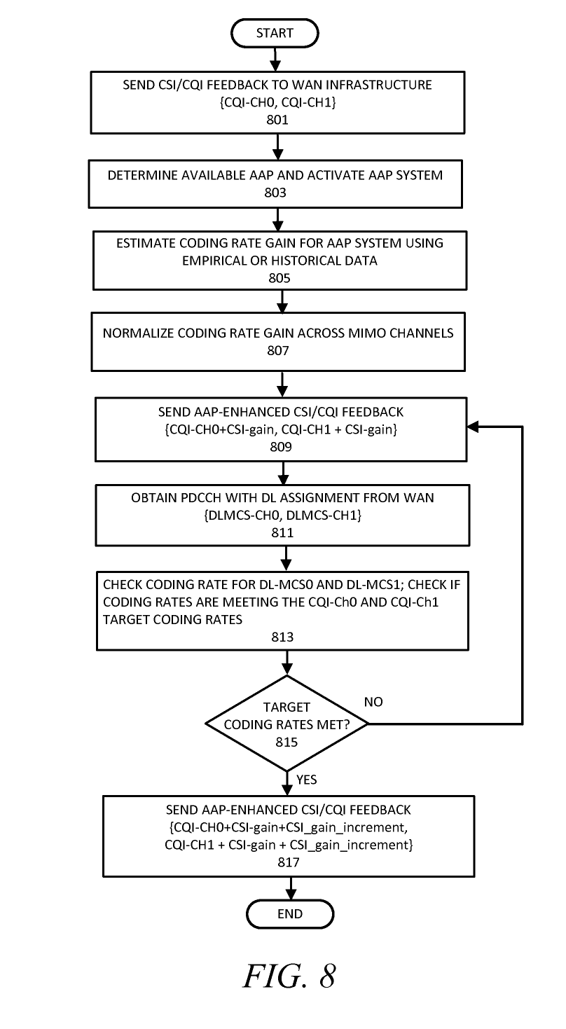

Further details of operation of a mobile device, such as mobile device 400, using the CQI and coding rate tables 427 are provided in the flowchart of FIG. 8. In the FIG. 8 example, the mobile device 400 is initially establishing communication over the WAN infrastructure and is in the downlink (DL) channel assignment process. Using the process of FIG. 8, the mobile device 400 influences channel quality feedback sent to the WAN infrastructure when using the AAP group for MIMO reception. In operation block 801, the mobile device 400 initially sends rank 2 CSI/CQI feedback to the WAN infrastructure such as to an eNode B. In operation block 803, the mobile device 400, AAP aggregator 470 determines the available AAPs from trusted devices 109 and public devices 111 that can be detected by the mobile device, and activates an AAP group of selected AAPs. In operation block 805, the AAP aggregator 470 may estimate the coding rate gain for the AAP group using empirical or historical data stored in memory 415. This data may be stored in the user profile 425 as discussed above or in the modality table 429 or in a combination of both.

The coding rate gain estimation in operation block 805 may include an open loop component and a closed loop component. For example the open loop gain can be considered to be the summation of the selected (or candidate) AAP gains such that an Open Loop CSI Gain-Sigma*Fn(AAP)*=CodeRateGainOL. The expected coding rate gains may then be mapped to a low value or to empirically derived data (i.e. past historical measurements for the AAPs as described above). This approach may be used for cold-starts, that is when the mobile device forms a new AAP group. Based on antenna efficiencies, a baseline is determined. For example, the past measurements stored in memory may include data for an automobile AAP versus a smartwatch AAP. The closed loop gain can then may use of this historical data based on the achieved coding rate using the particular AAP device (or for a particular AAP group). Referring to the closed loop AAP coding rate gain as CodeRateGainCL; then CSI Gain=MapCQI(CodeRateGainCL|CodeRateGainOL). For example, in the open loop the coding rate gains can be started from a base-value and can be incremented at the rate of 0.25 bits/sym/Hz (bits-per-symbol-per-Hertz).

In operation block 807, once CSI-gain has been computed, it is normalized across the channels (Channel0 and Channel1). In one example, if the CQI (coding rate) for Ch0 and Ch1 are {7(1.48), 3(0.38)}, then the CSI-gain is normalized across CQI values. In this case this could be, for example, {7.5(1.73), 34(0.63)}. In operation block 809, this “enhanced” CSI/CQI feedback is reported to the WAN infrastructure. In some embodiments, the CQI on the channels that is reported to the WAN infrastructure in operation block 809 (i.e. the Ch0 to Ch1 CQI ratio) can be adjusted by the AAP aggregator between AAPs so as to influence resource grants in view of the coding rate improvement. Accordingly, the AAP aggregator can influence resources utilized by specific preferred AAP devices. This can be advantageous for a number of reasons such as, but not limited to, AAP modality changes for example a reduction in power state below 25 percent or some other modality change. Accordingly in operation block 811, the mobile device receives the PDCCH (Physical Downlink Control Channel) with the DL assignment from the WAN infrastructure having the MCS (modulation and coding scheme) for channel 0 and channel 1. More generally, downlink radio resources are assigned to the mobile device. The term “radio resources” refers to time-frequency resources such as in an orthogonal-frequency-division-multiplexed (OFDM) system such as in the LTE downlink.

In operation block 813, the AAP aggregator checks the coding rate for the downlink assignments and checks whether the channel 0 and channel 1 CQI meets the target coding rates. In decision block 815, if the target coding rates are met, then in operation block 817 the mobile device can send enhanced CSI/CQI feedback that includes the CSI gain plus a CSI gain increment. The “CSI_Gain_Increment” is a variable value which is set to 0.25 bits/sym/Hz in one example embodiment. If in decision block 815 the target coding rates are not met in decision block 815, then the process returns to operation block 809.

In another embodiment, the CSI gain may be estimated is by using the CQI equivalence or coding equivalence which is mapped out from the component CQI for channel 0 and channel 1. More particularly, the objective is to have a single CSI_gain value and distribute it across the CQI for both codewords. The closed loop operation tracks successful decodes for the CSI-gain reported to the WAN and maintains the history for the AAP group and CSI-gains from empirical data stored in memory. The initial guidance from open-loop estimate is conservative and is slowly ramped. However better DL assignments and successful decodes increase the confidence of the CSI-gain computation.

FIG. 9 is an example CQI composite table 900 that is used in the above described processes to determine a CQI for reporting to the WAN infrastructure as in operation block 809. A CQI value for a first channel may be selected from the leftmost column and a CQI value for a second channel may be selected from the topmost row such that the intersecting value is the composite CQI that may be reported as feedback to the WAN infrastructure.

FIG. 10 is an example composite coding rate table 1000 which provides an alternative view of the composite CQI as a coding rate improvement labeled as the “coding gain” column. One or both of the tables of FIG. 9 and FIG. 10 are stored in the mobile device memory 415 as the CQI and coding rate tables 427 and are accessible by the AAP aggregator 470 for implementation of the above described processes.

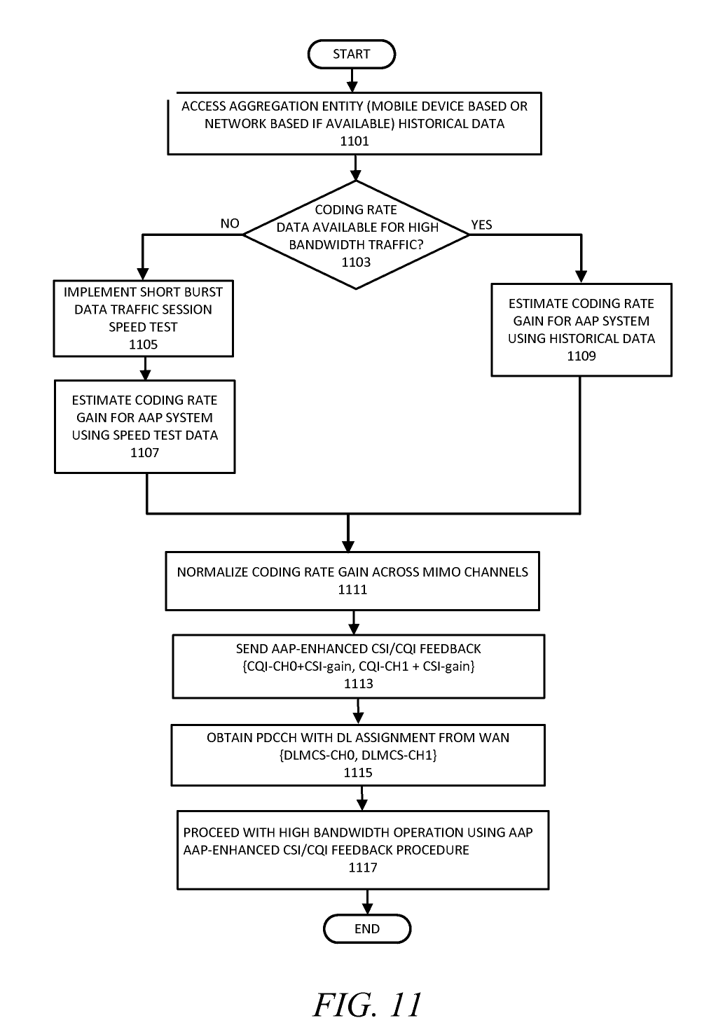

FIG. 11 is a flowchart of an example mobile device process for obtaining downlink channel assignments from a wide area network. In operation block 1101, an AAP aggregation entity provides AAP historical data for high bandwidth operations such as streaming media. The AAP aggregation entity may be the AAP aggregator 460 shown in FIG. 4 (mobile device based) or may be the cloud based AAP aggregation entity 201 as illustrated in FIG. 2 or may be a distributed AAP aggregation system with a mobile device component and a cloud based component. In decision block 1103, if coding rate historical data is available for high bandwidth traffic and for the available AAP types, then this historical data is used to estimate a coding rate gain in operation block 1109. However, if historical data is not available, then in operation block 1105 the mobile device implements a short burst data traffic session in order to conduct a speed test. This may be done using AAPs, or using the mobile device antennas and one or more AAPs.

One approach to conducting the speed test is to assemble other data such as email downloads, application synchronizations to servers or other low rate data into packets appropriate to simulate high demand data. In other words, the lower rate data is used to create the appearance of a data flood or full data buffer scenario at the mobile device from the perspective of the WAN so as to artificially induce a maximum downlink allocation from the WAN. In operation block 1107, the mobile device estimates the coding rate gain for an AAP system using the speed test data, i.e. the CQI values observed during the test. In operation block 1111, after estimation of the coding rate gain (and CSI-gain determination), it is normalized across the channels (Channel0 and Channel1) as described in the process shown in FIG. 8. In operation block 1113, this enhanced CSI/CQI feedback is reported to the WAN infrastructure and accordingly in operation block 1115, the mobile device receives the PDCCH with the DL assignment from the WAN infrastructure having the MCS for channel 0 and channel 1. The high bandwidth operation may then proceed and in operation block 1117 the procedures described with respect to FIG. 8 for AAP-enhanced CQI feedback may be applied. In accordance with the procedure of FIG. 11, traffic from the mobile device is shaped so as to obtain a maximum bandwidth allocation from the WAN when using the AAP group.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
accessing, by a mobile device, antenna equipment of at least a first antenna augmentation peripheral (AAP) using a first set of radio channels in a first frequency band for communication between the mobile device and the first AAP and using a second set of radio channels in a second frequency band for communication with a wide area network (WAN) to form a multiple input antenna system;
receiving, by the mobile device, a first performance metric for at least one channel of the second set of radio channels measured by the first AAP and sent to the mobile device using the first set of radio channels;
determining a composite performance metric using the first performance metric and a second performance metric related to the second set of radio channels;
reporting the composite performance metric as the mobile device performance metric to the WAN; and
obtaining, by the mobile device, a downlink radio resource assignment from the WAN based on the composite performance metric.

2. The method of claim 1, further comprising:
obtaining, by the mobile device, the second performance metric for a second channel from a second AAP; and
allocating, by the mobile device, the downlink radio resource assignment to one of the first AAP or the second AAP based on the first performance metric or the second performance metric.

3. The method of claim 2, further comprising:
estimating a coding rate gain for the second set of radio channels in communication with the WAN using historical data or empirical data for the first AAP and the second AAP.

4. The method of claim 3, further comprising:
selecting the first AAP and the second AAP from a group of AAPs based on the estimated coding rate gain estimated for the first AAP and the second AAP.

5. The method of claim 2, further comprising:
measuring gain increments for the first performance metric and for the second performance metric using the downlink radio resource assignment;
determining a second composite performance metric using the first performance metric and the second performance metric and the gain increments; and
reporting the second composite performance metric to the WAN.

6. The method of claim 2, further comprising:
reporting the composite performance metric to the WAN as a composite channel quality indicator (CQI).

7. The method of claim 2, further comprising:
implementing a short burst data traffic session as a speed test of the WAN for high bandwidth operation; and
estimating a coding rate gain for the multiple input antenna system comprising the first AAP and the second AAP;
determining the composite performance metric using the estimated coding rate gain; and
reporting the composite performance metric to the WAN to obtain additional downlink radio resource assignment.

8. The method of claim 7, further comprising:
aggregating application data from the mobile device to simulate a high bandwidth, full buffer condition to implement the short burst data traffic session.

9. The method of claim 1, further comprising:
using the first set of radio channels in the first frequency band for communication between the mobile device and the first AAP where the first frequency band is an unlicensed frequency band; and
using the second set of radio channels in the second frequency band for communication with a wide area network (WAN) where the second frequency band is a licensed frequency band.

10. A method comprising:
obtaining, by a mobile device, modality data from a group of antenna augmentation peripherals (AAPs) by communicating with each of the AAPs using a wireless interface;
determining, based on the modality data, the available AAPs from the group of AAPs;
assigning radio channels of a first set of radio channels in a first frequency band to each available AAP for communicating with the mobile device;
assigning radio channels of a second set of radio channels in a second frequency band to each available AAP for communicating with a wide area network (WAN); and
using the AAPs to form a multiple input antenna system for the mobile device.

11. The method of claim 10, further comprising:
measuring signal-to-noise-plus-interference ratio (SINR) for available radio channels in the second set of radio channels;
creating an ordered list of available radio channels based on the SINR;
mapping the ordered list of available radio channels to the AAPs.

12. The method of claim 10, further comprising:
obtaining the modality data as a packet having a plurality of bit fields, each bit field containing AAP operating mode information.

13. The method of claim 12, wherein determining, based on the modality data, the available AAPs from the group of AAPs, comprises:
assigning a numerical value to the plurality of bit fields such that each packet received from each AAP has an associated numerical value related to availability;
creating a list of AAP's using the numerical value;
selecting available AAPs of the group by selecting each AAP based on its associated numerical value.

14. The method of claim 12, further comprising:
obtaining the packet comprising a user context bit field, a device context bit field, and a user interaction state bit field.

15. The method of claim 12, wherein assigning a numerical value to the plurality of bit fields such that each packet received from each AAP has an associated numerical value related to availability, comprises:
assigning a score to each bit field of the packet to produce an overall availability score for each AAP.

16. The method of claim 15, wherein assigning a score to each bit field comprises:
assigning a score related to movement and speed, orientation in space, how the AAP is being held with respect to user grip on the AAP, types of applications running on the AAP device, and percentage of remaining battery charge.

17. A mobile device comprising:
antenna equipment comprising one or more antennas;
radio transceiver equipment, operatively coupled to the antenna equipment, operative to communicate with one or more antenna augmentation peripherals (AAPs) using a first set of radio channels in a first frequency band to form a multiple input antenna system, and operative to communicate with a wide area network (WAN) using a second set of radio channels in a second frequency band;
non-volatile, non-transitory memory comprising a composite channel quality indicator (CQI) table for determining a composite CQI for a first channel and a second channel in a multiple-input antenna system;
a processor operatively coupled to the memory and to the radio transceiver equipment, operative to:
access antenna equipment of at least a first AAP;
receive a first CQI value for at least one channel of the second set of radio channels measured by the first AAP;
determine a composite CQI using the first CQI value and a second CQI value related to the second set of radio channels;
report the composite CQI to the WAN as the mobile device CQI; and
obtain a downlink radio resource assignment from the WAN based on the composite CQI.

18. The mobile device of claim 17, wherein the processor is further operative to:
obtain the second CQI value for a second channel from a second AAP; and
allocate the downlink radio resource assignment to one of the first AAP or the second AAP based on the first CQI value or the second CQI value.

19. The mobile device of claim 17, wherein the processor is further operative to:
obtain modality data from a group of AAPs;
determine, based on the modality data, the available AAPs from the group of AAPs;
assign radio channels of the first set of radio channels in the first frequency band to each available AAP for communicating with the mobile device;
assign radio channels of the second set of radio channels in the second frequency band to each available AAP for communicating with the WAN; and
use the AAPs to form a multiple input antenna system for the mobile device.

20. The mobile device of claim 20, wherein the processor is further operative to:
obtain, from the radio transceiver equipment, signal-to-noise-plus-interference ratio (SINR) for available radio channels in the second set of radio channels;
create an ordered list of available radio channels based on the SINR; and
map the ordered list of available radio channels to the AAPs.
